(19) United States
(12) Patent Application Publication
(10) Pub. No.: US 2023/0383552 A1
(43) Pub. Date: Nov. 30, 2023

(54) CONSTRUCTION SYSTEM FOR CONSTRUCTION WORK

(71) Applicant: FIVEGRAND INTERNATIONAL CO., LTD., New Taipei City (TW)

(72) Inventor: TING-JUI WANG, New Taipei City (TW)

(21) Appl. No.: 18/321,802

(22) Filed: May 23, 2023

(30) Foreign Application Priority Data
May 26, 2022 (TW) 111119629

(51) Int. Cl. E04F 21/18; E04F 21/02; B25J 11/00

(52) U.S. Cl. CPC E04F 21/1872; B25J 11/0075; E04F 21/023

(57) ABSTRACT

A construction system for construction work is applied to set up a construction object on a target position, and includes a carrier device, a coating structure, and a setup structure. A feed structure is arranged on the carrier device and is used to provide an intermediate material. The coating structure is used to coat the target position with the intermediate material. The setup structure is used to set up the construction object on the target position via the intermediate material.

### CROSS-REFERENCE TO RELATED APPLICATION

This non-provisional application claims priority under 35 U.S.C. § 119(a) on Patent Application No(s). 111119629 filed in Taiwan, R.O.C. on May 26, 2022, the entire contents of which are hereby incorporated by reference.

### BACKGROUND OF THE INVENTION

### 1. Field of the Invention

The present disclosure provides a construction system for construction work, and in particular to a construction system for construction work to substitute machines for human labor.

### 2. Description of the Related Art

Current tiling work mostly requires manual operations, resulting in slow construction. Moreover, operation errors may frequently occur during manual operations, accordingly causing a waste in cement and construction delay.

### BRIEF SUMMARY OF THE INVENTION

With extensive research and development, a construction system for construction work is provided in the aim of substituting a machine for human labor, so as to prevent human errors.

A construction system for construction work is provided according to an embodiment of the present disclosure. The construction system is applied to set up a construction object on a target position, and includes a carrier device, a coating structure, and a setup structure. The coating structure is used to coat a target position with an intermediate material. The setup structure is used to set up the construction object on the target position via the intermediate material.

A construction system for construction work is provided according to an embodiment of the present disclosure, and further includes a feed structure. The feed structure is arranged on the carrier device and is used to provide the intermediate material.

A construction system for construction work is provided according to an embodiment of the present disclosure. The construction system is applied to set up a construction object on a target position, and includes a feed structure, a coating structure, and a setup structure. The feed structure is used to provide an intermediate material. The coating structure is used to receive the intermediate material provided by the feed structure and coat the target position with the intermediate material. The setup structure is used to set up the construction object on the target position via the intermediate material.

A construction system for construction work is provided according to an embodiment of the present disclosure. The construction system is applied to set up a construction object on a target position and includes a feed structure and a setup structure. The feed structure is used to provide an intermediate material. The setup structure is used to set up the construction object on the target position via the intermediate material.

A construction system for construction work is provided according to an embodiment of the present disclosure. The construction system is applied to set up a construction object on a target position and includes a coating structure and a setup structure. The coating structure is used to perform coating with an intermediate material. The setup structure is used to set up the construction object on the target position via the intermediate material.

A construction system for construction work is provided according to an embodiment of the present disclosure. The construction system is applied to set up a construction object on a target position and includes a setup structure. The setup structure is used to set up the construction object on the target position via the intermediate material.

A construction system for construction work is provided according to an embodiment of the present disclosure. The construction system is applied to set up a construction object on a target position and includes a setup structure. The setup structure is used to set up the construction object on the target position.

A construction system for construction work is provided according to an embodiment of the present disclosure. The construction system includes a feed structure and a coating structure. The feed structure is used to provide a material. The coating structure is used to receive the material provided by the feed structure and coat a target position with the material.

A construction system for construction work is provided according to an embodiment of the present disclosure. The construction system includes a coating structure. The coating structure is used to coat a target position with a material.

A method of use for a construction system for construction work is provided according to an embodiment of the present disclosure. The method applies the construction system for construction work described above, so as to coat the target position with the intermediate material or the material, or to set up the construction object on the target position.

Thus, the construction system for construction of the present disclosure is capable of automatically setting up the construction object on the target position, hence preventing manual operation errors.

### BRIEF DESCRIPTION OF THE DRAWINGS

FIG. 1A is a schematic diagram of a coating system applicable to a construction system for construction work according to an embodiment of the present disclosure.

FIG. 1B is a schematic diagram of a coating system applicable to a construction system for construction work according to an embodiment of the present disclosure.

FIG. 1C is a schematic diagram of a coating system applicable to a construction system for construction work according to an embodiment of the present disclosure.

FIG. 1D is a schematic diagram of a coating system applicable to a construction system for construction work according to an embodiment of the present disclosure.

FIG. 2 is a schematic diagram of a coating system applicable to a construction system for construction work according to an embodiment of the present disclosure.

FIG. 3 is a block diagram of a construction system for construction work according to an embodiment of the present disclosure.

FIG. 4 is a diagram of an operation for setting up a construction object by a construction system for construction work according to an embodiment of the present disclosure.

FIG. 5 is an enlarged perspective schematic diagram of an operation for setting up a construction object by a setup structure according to an embodiment of the present disclosure.

FIG. 6 is a schematic diagram of a construction system for construction work performing coating with an intermediate material and setting up a construction object according to an embodiment of the present disclosure.

FIG. 7 is a schematic diagram of an operation for thickness detection performed by a feature detector according to an embodiment of the present disclosure.

FIG. 8 is a schematic diagram of an operation of an identification device according to an embodiment of the present disclosure.

FIG. 9 is a side view schematic diagram of a setup body and a motion mechanism movably connected according to an embodiment of the present disclosure.

FIG. 10 is a diagram of an operation for setting up a construction object by a construction system for construction work according to an embodiment of the present disclosure.

### DETAILED DESCRIPTION OF THE INVENTION

To facilitate understanding of the objectives, characteristics, and effects of this present disclosure, embodiments together with the attached drawings for the detailed description of the present disclosure are provided.

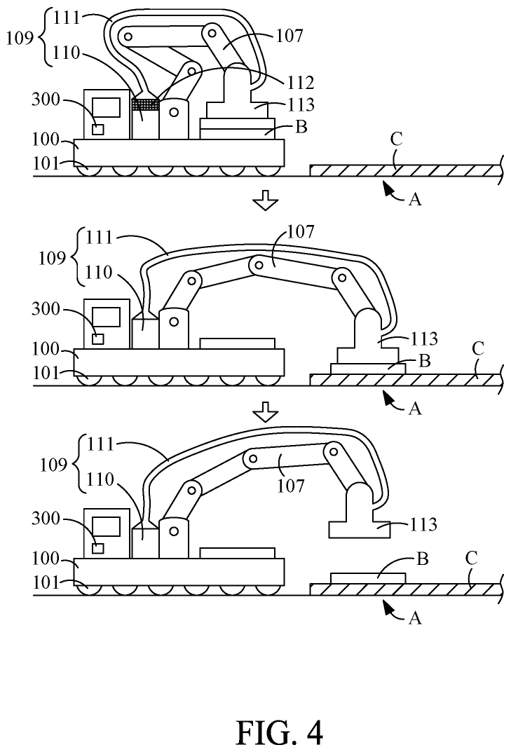

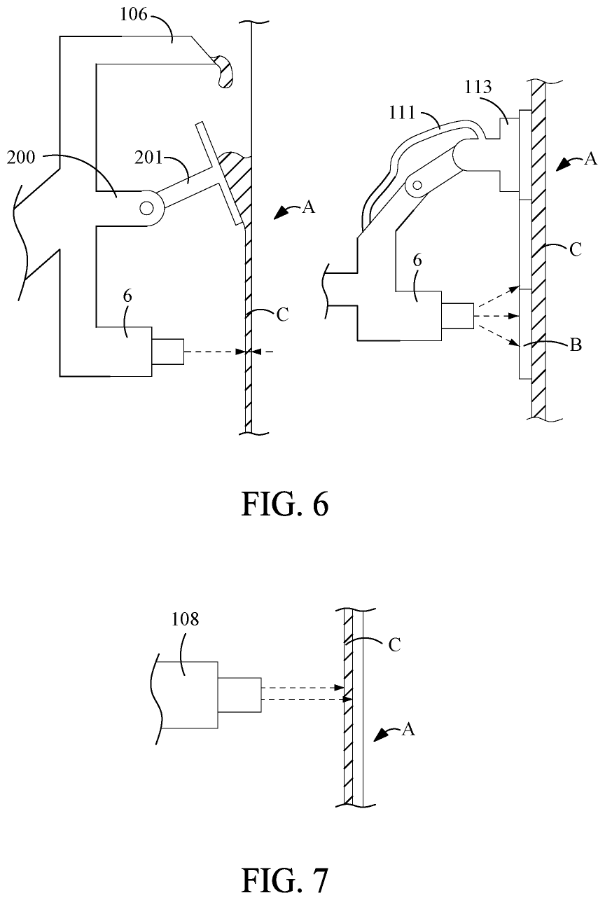

Referring to FIG. 3 to FIG. 9, a construction system 105 for construction work is according to an embodiment of the present disclosure. The construction system 105 includes a carrier device 100, a coating structure 200, and a setup structure 107. As shown in FIG. 3 and FIG. 6, the coating structure 200 is used to coat a target position with an intermediate material C. As shown in FIG. 4 to FIG. 6, the construction system 105 is applied to set up a construction object B on the target position A. The setup structure 107 is used to set up the construction object B on the target position A via the intermediate material C. For example, the setup structure 107 is used to set up the construction object B on the target position A coated with the intermediate material C. In the embodiments below, the setup structure 107 performs a task of attaching; however, other setup operations performed by the setup structure 107 may further include mounting, soldering, placing, fastening, gluing, magnetizing, vacuum suction, installing, riveting, or inserting.

A construction system 105 for construction work according to an embodiment of the present disclosure further includes a feed structure 106. The feed structure 106 is arranged on the carrier device 100 and is used to provide the intermediate material C.

A construction system 105 for construction work according to an embodiment of the present disclosure is applied to set up a construction object B on a target position A, and includes a feed structure 106, a coating structure 200, and a setup structure 107. The feed structure 106 is used to provide an intermediate material C. The coating structure 200 is used to receive the intermediate material C provided by the feed structure 106, and to coat the target position A with the intermediate material C. The setup structure 107 is used to set up the construction object B on the target position A via the intermediate material C. For example, the setup structure 107 is used to set up the construction object B on the target position A coated with the intermediate material C.

A construction system 105 for construction work according to an embodiment of the present disclosure is applied to set up a construction object B on a target position A and includes a feed structure 106 and a setup structure 200. The feed structure 106 is used to provide an intermediate material C. The setup structure 107 is used to set up the construction object B on the target position A via the intermediate material C. For example, the setup structure 107 is used to set up the construction object B on the target position A coated with the intermediate material C.

A construction system 105 for construction work according to an embodiment of the present disclosure is applied to set up a construction object B on a target position A and includes a coating structure 200 and a setup structure 107. The coating structure 200 is used to perform coating with an intermediate material C. The setup structure 107 is used to set up the construction object B on the target position A via the intermediate material C. For example, the setup structure 107 is used to set up the construction object B on the target position A coated with the intermediate material C.

A construction system 105 for construction work according to an embodiment of the present disclosure is applied to set up a construction object B on a target position A and includes a setup structure 107. The setup structure 107 is used to set up the construction object B on the target position A via the intermediate material C. For example, the setup structure 107 is used to set up the construction object B on the target position A coated with the intermediate material C.

A construction system 105 for construction work according to an embodiment of the present disclosure is applied to set up a construction object B on a target position A and includes a setup structure 107. The setup structure 107 is used to set up the construction object B on the target position A.

A construction system 105 for construction work according to an embodiment of the present disclosure includes a feed structure 106 and a coating structure 200. The feed structure 106 is used to provide a material. The coating structure 200 is used to receive the material provided by the feed structure 106, and to coat a target position A with the material.

A construction system 105 for construction work according to an embodiment of the present disclosure includes a coating structure 200. The coating structure 200 is used to coat a target position A with a material.

A method of use for a construction system for construction work according to an embodiment of the present disclosure. The method applies the construction system 105 for construction work described above, so as to coat the target position A with the intermediate material C or other materials, or to set up the construction object B on the target position A.

Thus, the construction system 105 for construction of the present disclosure and the method of use thereof are capable of automatically setting up the construction object B on the target position A, hence preventing manual operation errors.

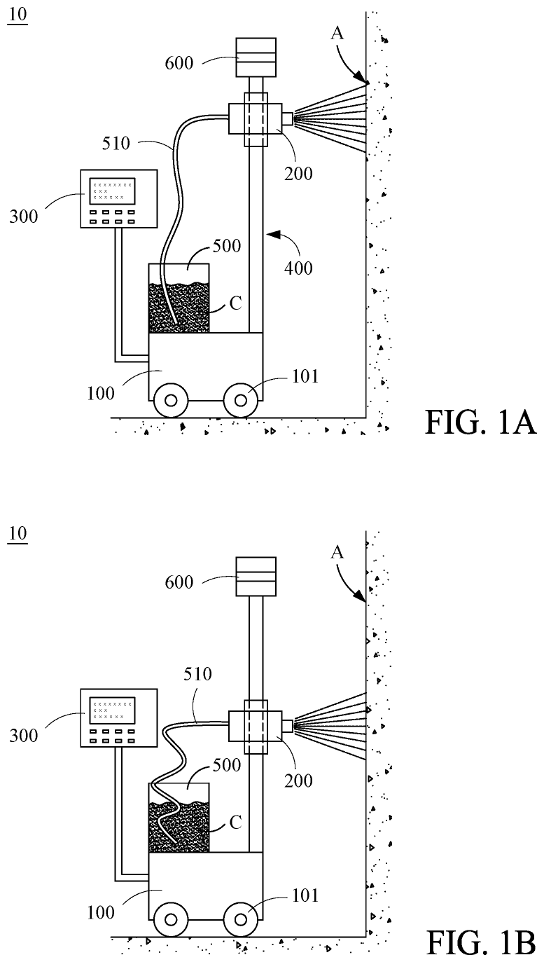

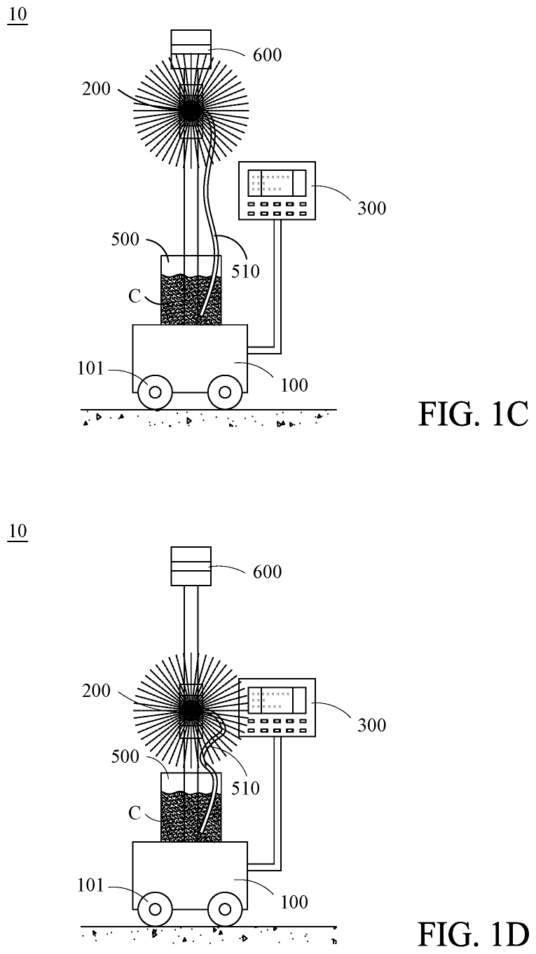

Referring to FIG. 3, FIG. 4 and FIG. 1A to FIG. 1D, a coating system 10 may include the carrier device 100, the coating structure 200, and a control device 300. The coating structure 200 is movably arranged on the carrier device 100. The control device 300 controls the coating structure 200 and has information corresponding to a target position A. Further, the control device 300 drives the coating structure 200 according to the information to coat the target position A with the intermediate material C, or drives the setup structure 107 according to the information to set up the construction object B on the target position A. More specifically, the control device 300 is electrically connected to the feed structure 106, the coating structure 200 and the setup structure 107. The information may be map information corresponding to the target position A; however, the present disclosure is not limited to the examples above. For example, the information may also be image information or identifiable signal information to be described in the embodiments below. The information may be, for example but not limited to, stored in advance in the control device 300. The carrier device 100 may be, for example but not limited to, a platform or a frame. The control device 300 is, for example, a computer, tablet computer, cellphone, application device, artificial intelligence device, network device, or remote controller. The control device 300 may be installed with at least a set of software including software for controlling the construction system 105, image recognition software, neural network or graph comparison software, two-dimensional construction software, or three-dimensional construction software, so as to control all devices in the construction system 105. The control device 300 may also be installed with software to control a spray coating amount, spray coating speed, or spray coating thickness of the intermediate material C that the coating structure sprays on the target position A. The control device 300 may also be signally connected to a remote device. The remote device may be a computer or a mobile device. The remote device is installed with the software when it is the computer, and is installed with an application for controlling the software when it is the mobile device.

As shown in FIG. 3 and FIG. 7, in an embodiment, the construction system 105 may further include a feature detector 108. The feature detector 108 is arranged on the carrier device 100, electrically connected to the control device 300 and used to perform material sensing, thickness sensing, material measurement, or thickness measurement of the intermediate material C coated on the target position A, that is, sensing coating conditions of the target position A. The feature detector 108 may include an infrared, nuclear magnetic resonance, or hardness sensing module.

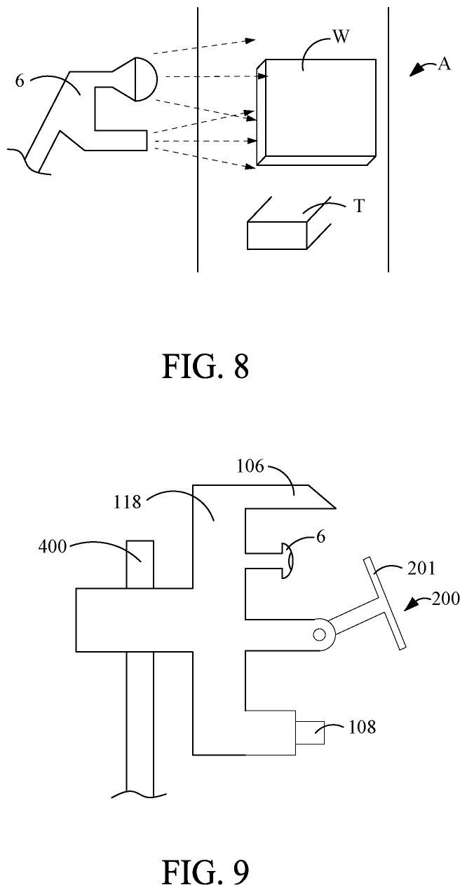

As shown in FIG. 3, FIG. 8 and FIG. 9, in an embodiment, the construction system 105 of an embodiment of the present disclosure may further include an identification device 6. The identification device is connected to the control device 300 and linked with the coating structure 200, the feed structure 106, or the setup structure 107. The identification device 6 is used to determine the form or pattern of the target position A, or for the coating structure 200, the feed structure 106, or the setup structure 107 to skip a non-predetermined coating, non-predetermined feeding, or non-predetermined setup position, or adjust a distance from the target position A. For example, in FIG. 8, the target position A has a window W that does not need to be coated and has a step T. Referring to FIG. 6, the identification device 6 is used to further identify, set, or calculate a distance of a predetermined distance in between each construction object B, so as to place the construction object B at a set distance or position. The identification device 6 may include a visual device, a scan device, a comparison device, a positioning device, a calculation device, a measurement device, or an imaging device.

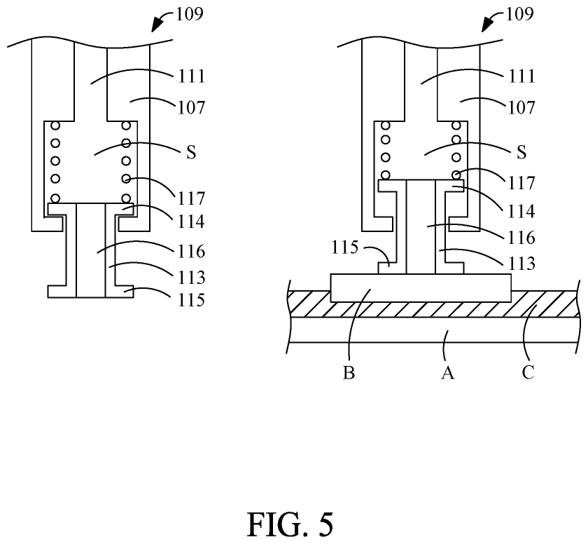

As shown in FIG. 4 to FIG. 6, in an embodiment, the setup structure 107 may be integrated in a vacuum suction mechanism 109, so as to suck and attach the construction object B by vacuum suction during setup. The vacuum suction mechanism 109 includes an air compressor 110 and a vacuum pipeline 111. The air compressor 110 is arranged at the carrier device 100, and the vacuum pipeline 111 is arranged at the setup structure 107 and is connected to the air compressor 110. The air compressor 110 may be further provided with a filter 112 to filter out dust or impurities. The setup structure 107 may include a mechanical arm, and the vacuum pipeline 111 is in communication with the setup structure 107. As shown in FIG. 5, the setup structure 107 may have a motion space S in communication with the vacuum pipeline 111, and include a movable pressure unit 113 used to press the construction object B. The movable pressure unit 113 has an inner end 114 limited within the motion space S and an outer end 115 located outside the motion space S. The movable pressure unit 113 may further have a through hole 116 in communication with the motion space S. The setup structure 107 may further include a pressure element 117. The pressure element 117 may be a damping element or an elastic element. The pressure element 117 is connected or abutted between the inner end 114 and an inner wall of the motion space S, so as to provide the movable pressure unit 113 with a pressurizing force on the construction object B, or to provide a buffer force, or to provide elasticity, or to control a depth by which the construction object B is pressed into the intermediate material C, or to limit a pressurizing force. In FIG. 4 and FIG. 5, the construction system 105 sets up the construction object B on the target position A located on the ground. In FIG. 5, the construction system 105 sets up the construction object B on the target position A located on a wall. In FIG. 6, the identification device 6 is linked with the setup structure 107; however, the present disclosure is not limited to the above examples, and the identification device 6 may not be linked with the setup structure 107.

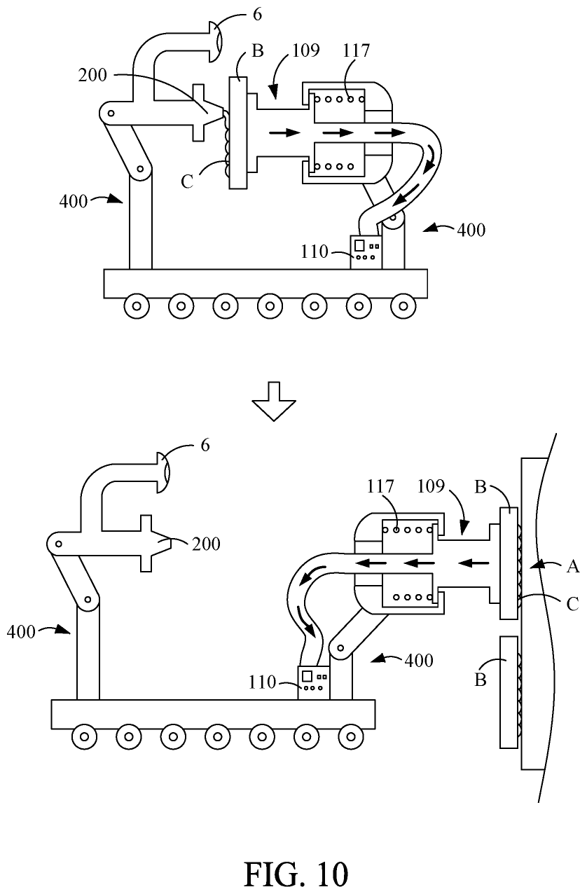

As shown in FIG. 10, in an embodiment, the coating structure 200 is used to first coat the construction object B with the intermediate material C or other materials, and then use the setup structure 107 to set up the construction object B on the target position A. The identification device 6 is used to identify the position of the construction object B or a target position to be coated of the construction object B, so as to coat the construction object B with the intermediate material C or other material, and then set up the coated construction object B on the target position A.

As shown in FIG. 4 to FIG. 7, in an embodiment, the intermediate material B or the other material includes, for example, cement, a mixture with cement as the main ingredient, adhesives, dispensing adhesives, self-adhesives, double-sided tapes, glue, paint, or sticky objects, or the construction object B is, for example, wall tiles, floor tiles, wooden bodies, fabric, paper, leather, wallpaper, metal bodies, plastic bodies, or stone bodies, or the material of the construction object B is, for example, tiles, concrete bricks, or bricks. The construction object B may have a self-adhesive ability, a self-adhesive material, a self-attaching ability, a self-attaching material, a self-attractive ability, a self-attractive material, a self-setting ability, a self-setting material, or a self-fastening ability.

As shown in FIG. 3 and FIG. 9, in an embodiment, the coating structure 200, the feed structure 106, the feature detector 108, and the identification device 6 may be connected to a setup body 118 to be linked together. The setup body 118 may be movably connected to a motion mechanism 400 arranged on the carrier device 100. The motion mechanism 400 may be a slide bar for sliding and connecting the setup body 118. When driven by the control device 300, the setup body 118 can move vertically on the carrier device 100. However, the present disclosure is not limited to the above examples. The coating structure 200 may be provided with an apply-and-press member 201, for example, a nozzle, a brush, a trowel, a blade, a roller, an inclined surface body, a curved surface body, or a planar surface body. In an embodiment that is not shown, any combination of the coating structure 200, the feed structure 106, the feature detector 108, and the identification device 6 may also be linked together. Also referring to FIG. 6, the feature detector 108 and the identification device 6 may also be used to identify whether to work on the target position A, whether to skip the target position A, or whether to avoid or move close to the target position A. In other embodiments, the coating structure 200, the feed structure 106, the feature detector 108, and the identification device 6 may also be separated from one another and are not altogether linked to the setup body 118.

As shown in FIG. 3, FIG. 6, and FIG. 1A to FIG. 1D, in an embodiment, the construction system 105 may further include a storage tank 500 arranged on the carrier device 100 and a pipeline 510 connecting between the storage tank 500 and the coating structure 200. The storage tank 500 is used to store the intermediate material C and supply the intermediate material C to the feed structure 106 through the pipeline 510. The feed structure 106 may be a pipe and located above the coating structure 200. The pipeline 510 in FIG. 1A to FIG. 1D is merely illustrative, and a conveyor pump (not shown) may be further arranged on the carrier device 100 to transport the intermediate material C.

As shown in FIG. 4 and FIG. 1A to FIG. 1D, in an embodiment, the carrier device 100 is provided with a motion section 101 on a bottom thereof for the carrier device 100 to move according to application route requirements. The motion section 101 includes a plurality of wheels, and a user may move the carrier device 100 after the coating operation is complete or according to operation requirements, so as to allow the coating structure 200 to move to in front of different target positions A. The carrier device 100 may perform motion in a lateral, longitudinal, or an arbitrary direction through the motion section 101, for example, moving along a plane parallel to the target position A. The control device 300 is used to provide a motion instruction to the motion section 101 and to provide a coating instruction to the coating structure 200. The motion instruction is used to control a movement position, movement distance, and movement direction of the motion section 101, and the motion instruction may be integrated with the coating instruction so as to control a coating sequence of the coating structure 200 with respect to the target position A or to adjust a control relationship between coating instructions.

As shown in FIG. 1A to FIG. 1D, in an embodiment, the coating system 10 further includes an alarm device 600 arranged on the carrier device 100 and electrically connected to the control device 300. The alarm device 600 is used to issue a warning light or sound when the coating system 10 malfunctions. For example, the alarm device 600 is a warning light, a beeper, or an alarm device combining the two functions above. The alarm device 600 may be arranged, for example but not limited to, on a top portion of the motion mechanism 400 of the slide bar, so as to facilitate the user to timely notice any abnormal situations.

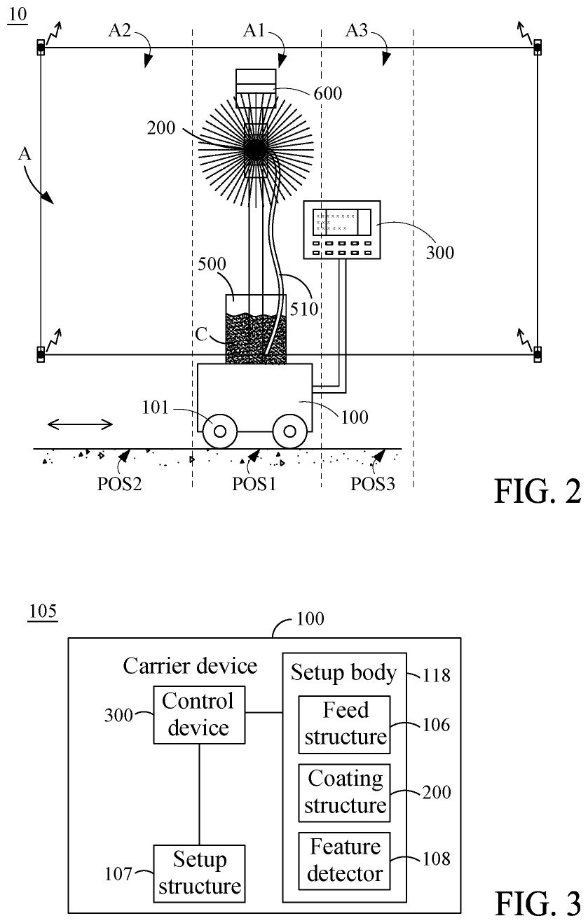

As shown in FIG. 2, in an embodiment, the control device 300 may control the coating structure 200 to perform matrix movement, longitudinal movement, lateral movement, or rotational movement. The carrier device 100 is located at a current position POS1 while the coating structure 200 coats a first target position A1, and the carrier device 100 is adapted to be moved so that the construction system 105 for construction work of the embodiment reaches a second current position POS2 once the coating structure 200 completes the coating task on the first target position A1, for the coating structure 200 to coat the second target position A2. Similarly, the carrier device 100 then moves to a third current position POS3 so that a third target position A3 can be coated. The control device 300 may be used to control the carrier device 100 to move among different positions in response to a coating sequence of the coating structure 200 corresponding to different target positions. For example but not limited to, the control device 300 may move the carrier device 100 by controlling the motion section 101, or the user may manually push the carrier device 100. However, the control device 300 may control the coating structure 200 to only move among different current positions. Referring to FIG. 9, in an embodiment, the control device 300 is also used to control the feed structure 106 or the setup structure 107 to perform a matrix movement, longitudinal movement, lateral movement, or rotational movement. When the coating structure 200, the feed structure 106, or the setup structure 107 performs coating, feeding, and setup on the first target position, the carrier device 100 is located on the first current positions POS1. Once the coating structure 200, the feed structure 106, and the setup structure 107 complete the respective coating, feeding, and setup tasks on the first target position A1, the carrier device 100 is adapted to be moved to the second current position POS2 for the coating structure 200, the feed structure 106, and the setup structure 107 to perform coating, feeding, and setup on the second target position A2. More specifically, the control device 300 is used to control the carrier device 100 to correspond to coating, feeding, or setup sequences of the coating structure 200, the feed structure 106, and the setup structure 107 on different target positions A, and to move among different current positions.

As shown in FIG. 1, FIG. 5A to FIG. 5C, and FIG. 9, in an embodiment, the coating structure 200 is turnable or rotatable relative to the carrier device 100 in response to a non-planar target position A, so as to coat the target position A. The coating structure 200 may be, for example but not limited to, pivotally connected to the motion mechanism 400 of the slide bar. It should be noted that, the coating structure 200 turnable or rotatable relative to the carrier device 100 may also coat a planar target position A.

The present invention is described by way of the preferred embodiments above. A person skilled in the art should understand that, these embodiments are merely for describing the present invention and are not to be construed as limitations to the scope of the present invention. It should be noted that all equivalent changes, replacements, and substitutions made to the embodiments are to be encompassed within the scope of the present invention. Therefore, the scope of protection of the present invention should be accorded with the broadest interpretation of the appended claims.

What is claimed is:

1. A construction system for construction work applied to set up a construction object on a target position, the construction system comprising:
a feed structure, used to provide an intermediate material; and
a setup structure, used to set up the construction object on the target position via the intermediate material.

2. The construction system for construction work according to claim 1, further comprising a coating structure used to receive the intermediate material provided by the feed structure, and to coat the target position with the intermediate material.

3. The construction system for construction work according to claim 1, wherein the setup structure is a vacuum suction structure to suck and attach the construction object by vacuum suction during setup.

4. The construction system for construction work according to claim 3, wherein the vacuum suction structure comprises an air compressor and a vacuum pipeline, and the vacuum pipeline is arranged at the setup structure and is connected to the air compressor.

5. The construction system for construction work according to claim 3, wherein the setup structure comprises a motion space or a movable pressure unit.

6. The construction system for construction work according to claim 3, wherein the setup structure further comprises a pressure element used to provide the setup structure or a movable pressure unit with a pressurizing force on the construction object, or to provide a buffer force, or to provide elasticity, or to control a depth by which the construction object is pressed into the intermediate material, or to limit the pressurizing force.

7. The construction system for construction work according to claim 1, further comprising:
a control device, used to control the coating structure, the feed structure, or the setup structure, the control device having information corresponding to the target position, and used to drive the coating structure according to the information to coat the target position, or to drive the setup structure according to the information to set up the construction object to the target position.

8. The construction system for construction work structure according to claim 1, further comprising:
a control device, used to control the coating structure, the feed structure, or the setup structure to perform a matrix movement, longitudinal movement, lateral movement, or rotational movement;
wherein, the carrier device is located on a current position while the coating structure, the feed structure, or the setup structure performs coating, feeding, or setting up on the target position; once the coating structure, the feed structure, or the setup structure completes a coating, feeding, or setting up task on the target position, the construction system for construction work is adapted to be moved to another current position for the coating structure, the feed structure, or the setup structure to perform coating, feeding, or setting up on another target position; or the control device is used to control a carrier device to correspond to a coating, feeding, or setting up sequence of the coating structure, the feed structure, or the setup structure for different positions, and to move among different current positions.

9. The construction system for construction work according to claim 1, further comprising:
an identification device, used to identify, set, or calculate a distance of a predetermined distance in between each construction object, so as to place the construction object at a set distance or position.
